(19) United States
(12) Patent Application Publication
(10) Pub. No.: US 2021/0025782 A1
(43) Pub. Date: Jan. 28, 2021

(54) PARTICULATE MATTER DETECTION DEVICE

(71) Applicant: DENSO CORPORATION, Kariya-city (JP)

(72) Inventors: Kazuhiko KOIKE, Nisshin-city (JP); Masahiro YAMAMOTO, Kariya-city (JP)

(21) Appl. No.: 17/066,745

(22) Filed: Oct. 9, 2020

Related U.S. Application Data
(63) Continuation of application No. PCT/JP2019/015387, filed on Apr. 9, 2019.

(30) Foreign Application Priority Data
Apr. 12, 2018 (JP) 2018-076958

(51) Int. Cl. G01M 15/10; F01N 11/00

(52) U.S. Cl. CPC G01M 15/102; F01N 2560/06; F01N 2560/05; F01N 11/002

(57) ABSTRACT

A particulate matter detection device includes a sensor element and a detection control unit. The sensor element includes a particulate matter detection unit and a temperature compensation unit. The particulate matter detection unit includes a pair of detection electrodes on a deposition surface of a detection conductive layer. The temperature compensation unit includes a pair of temperature compensation electrodes on a non-deposition surface of a temperature compensation conductive layer. The detection electrodes and the temperature compensation electrodes are connected to a common ground terminal. The detection control unit detects a first output signal based on an electrical resistance between the detection electrodes and detects a second output signal based on an electrical resistance between the temperature compensation electrodes, and calculates a deposition amount of particulate matter on the basis of a differential output between the first output signal and the second output signal.

### CROSS-REFERENCE TO RELATED APPLICATION

The present application is a continuation application of International Application No. PCT/JP2019/015387 filed on Apr. 9, 2019, which is based on and claims the priority to Japanese Patent Application No. 2018-076958 filed on Apr. 12, 2018. The contents of these applications are incorporated herein by reference in their entirety.

### BACKGROUND

The present disclosure relates to a particulate matter detection device.

Exhaust gas purification systems have been known in which a particulate filter is provided in an exhaust gas passage of an automobile engine in order to reduce particulate matter (hereinafter referred to as PM as appropriate) discharged from the exhaust gas passage to the outside. Exhaust gas purification systems have a self-diagnosis function and include, for example, a particulate matter detection device that detects particulate matter leaking downstream of the particulate filter, and perform fault diagnosis of the particulate filter on the basis of the detection result.

### SUMMARY

A first aspect of the present disclosure is a particulate matter detection device including: a sensor element for detecting particulate matter; and a detection control unit, wherein: the sensor element includes a particulate matter detection unit including a pair of detection electrodes and a temperature compensation unit including a pair of temperature compensation electrodes; the pair of detection electrodes are connected to a common ground terminal; the pair of temperature compensation electrodes are connected to the common ground terminal; the detection control unit includes a detection circuit unit and a particulate matter amount calculation unit; the detection circuit unit detects a first output signal based on the electrical resistance between the pair of detection electrodes and a second output signal based on an electrical resistance between the pair of temperature compensation electrodes; and the particulate matter amount calculation unit calculates the deposition amount of particulate matter on the basis of a differential output between the first output signal and the second output signal.

### BRIEF DESCRIPTION OF THE DRAWINGS

The above object and other objects, features, and advantages of the present disclosure will be more apparent from the following detailed description with reference to the accompanying drawings, wherein:

FIG. 1 is a perspective view showing a configuration of a sensor element of a particulate matter detection device according to Embodiment 1;

FIG. 2 is a schematic configuration diagram of the particulate matter detection device according to Embodiment 1;

FIG. 3 is a plan view of the sensor element according to Embodiment 1, and is a diagram viewed from a direction indicated by arrow III in FIG. 1;

FIG. 4 is a plan view of the sensor element according to Embodiment 1, and is a diagram viewed from a direction indicated by arrow IV in FIG. 1;

FIG. 5 is a partial enlarged cross-sectional view showing a state in which no particulate matter is deposited on a deposition surface of the sensor element according to Embodiment 1;

FIG. 6 is a partial enlarged cross-sectional view showing a state in which particulate matter is deposited on the deposition surface of the sensor element according to Embodiment 1;

FIG. 7 is a diagram showing a relationship between a deposition amount of particulate matter and an electric current flowing between a pair of detection electrodes according to Embodiment 1;

FIG. 8 is a diagram showing a method of measuring a surface electrical resistivity p according to Embodiment 1;

FIG. 9 is a diagram showing a method of measuring a bulk electrical resistivity according to Embodiment 1;

FIG. 10 is an overall configuration diagram of an exhaust purification system including the particulate matter detection device according to Embodiment 1;

FIG. 11 is a flow chart of a particulate matter detection process performed by a sensor control unit of the particulate matter detection device according to Embodiment 1;

FIG. 12 is a diagram showing a change over time in output of the sensor element according to Embodiment 1;

FIG. 13 is a perspective view showing a configuration of a sensor element of a particulate matter detection device according to Comparative Embodiment 1;

FIG. 14 is a diagram showing a change over time in output of the sensor element according to Comparative Embodiment 1;

FIG. 15 is a schematic configuration diagram of a particulate matter detection device according to Embodiment 2;

FIG. 16 is a diagram showing a relationship between an output of a sensor element and a temperature in an ideal state according to Embodiment 2;

FIG. 17 is a diagram showing a relationship between the output of the sensor element and the temperature in an actual state according to Embodiment 2;

FIG. 18 is a flow chart of a particulate matter detection process performed by a sensor control unit of the particulate matter detection device according to Embodiment 2;

FIG. 19 is a diagram showing a relationship between an output of a sensor element and a temperature according to Embodiment 3;

FIG. 20 is a flow chart of a particulate matter detection process performed by a sensor control unit of a particulate matter detection device according to Embodiment 3;

FIG. 21 is a diagram showing a relationship between an element temperature and an output of a sensor element according to Embodiment 4;

FIG. 22 is a flow chart of a particulate matter detection process performed by a sensor control unit of a particulate matter detection device according to Embodiment 4;

FIG. 23 is a perspective view showing a configuration of a sensor element of a particulate matter detection device according to Embodiment 5; and

FIG. 24 is a plan view of the sensor element according to Embodiment 5.

### DETAILED DESCRIPTION OF THE PREFERRED EMBODIMENTS

The particulate matter detection device includes, for example, an electrical resistance sensor element, and applies a voltage to a pair of detection electrodes provided on a surface of an insulating substrate to detect a change in electrical resistance between the pair of detection electrodes caused by deposition of particulate matter whose main component is conductive soot. In this method, time until particulate matter is deposited and the pair of detection electrodes are electrically connected to each other is dead time during which the electrical resistance is not changed. Thus, it has been desired to reduce the dead time and allow detection of PM at an earlier timing.

JP 2016-138449 A proposes a particulate matter detection sensor that includes a pair of detection electrodes on a surface of a deposition portion on which part of particulate matter is deposited, and includes a high-resistance conductive layer formed to connect the pair of detection electrodes to each other. The high-resistance conductive layer is composed of a material having a higher electrical resistivity than the particulate matter, and an electrical resistance between the pair of detection electrodes varies according to the amount of particulate matter deposited on a surface of the high-resistance conductive layer. Therefore, by measuring the change in the electrical resistance, the amount of PM deposition can be detected without having a dead time.

The particulate matter detection sensor disclosed in JP 2016-138449 A has a problem in which the electrical resistivity of the high-resistance conductive layer is easily changed according to the temperature. Thus, even when the amount of PM deposition is constant, a change in the temperature of a measurement environment may cause a significant change in the electrical resistance between the detection electrodes, thereby preventing accurate detection of the amount of PM deposition. Furthermore, in this method, an electric current always flows between the pair of detection electrodes, and thus depending on the measurement environment, the detection of particulate matter is easily influenced by noise entering from the outside. In particular, when a very small amount of particulate matter is detected, the influence of noise that cannot be ignored may cause a reduction in the detection accuracy.

An object of the present disclosure is to provide a particulate matter detection device capable of eliminating the influence of temperature and noise in a measurement environment and accurately detecting particulate matter.

A first aspect of the present disclosure is a particulate matter detection device including: a sensor element for detecting particulate matter contained in measured gas; and a detection control unit connected to the sensor element, wherein: the sensor element includes a particulate matter detection unit and a temperature compensation unit; the particulate matter detection unit includes a detection conductive layer that is composed of a conductive material having a higher electrical resistivity than the particulate matter and has a deposition surface on which the particulate matter is deposited, and a pair of detection electrodes that are arranged on the deposition surface, and an electrical resistance between the pair of detection electrodes varies according to a deposition amount of particulate matter; the temperature compensation unit includes a temperature compensation conductive layer that is composed of the conductive material and has a non-deposition surface arranged at a position at which the particulate matter is not deposited, and a pair of temperature compensation electrodes that are arranged on the non-deposition surface; the pair of detection electrodes are connected to a first output terminal and a common ground terminal, respectively; the pair of temperature compensation electrodes are connected to a second output terminal and the common ground terminal, respectively; the detection control unit includes a detection circuit unit and a particulate matter amount calculation unit; the detection circuit unit is connected to the first output terminal and detects a first output signal based on the electrical resistance between the pair of detection electrodes, and is connected to the second output terminal and detects a second output signal based on an electrical resistance between the pair of temperature compensation electrodes; and the particulate matter amount calculation unit calculates the deposition amount of particulate matter on the basis of a differential output between the first output signal and the second output signal.

In the particulate matter detection device of the aspect, the detection control unit outputs the electrical resistance between the pair of detection electrodes of the particulate matter detection unit as the first output signal from the detection circuit unit to the particulate matter amount calculation unit. Furthermore, the detection control unit outputs the electrical resistance between the pair of temperature compensation electrodes of the temperature compensation unit as the second output signal. The particulate matter amount calculation unit calculates the differential output by subtracting the second output signal from the first output signal, and calculates the deposition amount of particulate matter.

In this case, the particulate matter detection unit and the temperature compensation unit are in an equivalent measurement environment and differ from each other only in that the particulate matter detection unit has the deposition surface on which particulate matter is deposited and the temperature compensation unit has the non-deposition surface on which no particulate matter is deposited. Thus, by calculating the differential output, it is possible to obtain an output that is not influenced by a change in the electrical resistance of the detection conductive layer and the temperature compensation conductive layer according to the temperature. Furthermore, since the pair of detection electrodes of the particulate matter detection unit and the pair of temperature compensation electrodes of the temperature compensation unit are connected to the common ground terminal, the influence of noise from the measurement environment is equivalent on the detection electrodes and the temperature compensation electrodes. Thus, the influence of noise is not exerted on the calculated differential output. Therefore, the deposition amount of particulate matter can be calculated with high accuracy by using the differential output from which the influence of temperature and noise is eliminated.

As described above, the above aspect can provide a particulate matter detection device capable of eliminating the influence of temperature and noise in a measurement environment and accurately detecting particulate matter.

### Embodiment 1

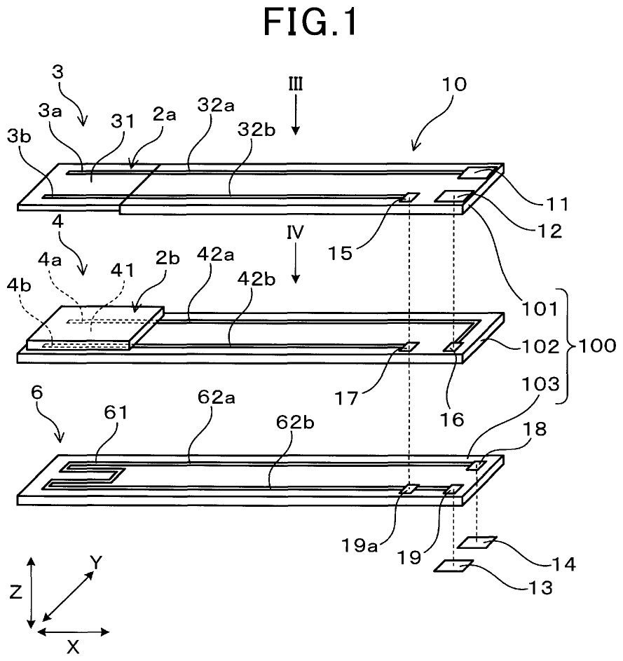

An embodiment of a particulate matter detection device will be described with reference to the drawings. As shown in FIGS. 1 to 4, a particulate matter detection device 1 includes a sensor element 10 for detecting particulate matter contained in measured gas, and a detection control unit 50 that is connected to the sensor element 10 and controls the detection of particulate matter. The measured gas is, for example, combustion exhaust gas discharged from an automobile engine, and contains particulate matter mainly composed of soot which is a conductive component. The discharge amount of particulate matter and a state of particles of the particulate matter, for example, a particle size and a chemical composition of the particulate matter are changed according to an operating state of the engine.

The sensor element 10 is an electrical resistance plate-like element, and includes a particulate matter detection unit (hereinafter referred to as PM detection unit) 3, a temperature compensation unit 4, a first output terminal 11, a second output terminal 12, and a common ground terminal 13. A heater unit 6 is incorporated in the sensor element 10 and controlled by a heater control unit 60. The detection control unit 50 together with the heater control unit 60 constitutes a sensor control unit 5.

The PM detection unit 3 includes a detection conductive layer 2a that is composed of a conductive material having a higher electrical resistivity than the particulate matter and has a deposition surface 31 on which the particulate matter is deposited, and a pair of detection electrodes 3a and 3b that are arranged on the deposition surface 31. The pair of detection electrodes 3a and 3b face each other with a part of the deposition surface 31 interposed therebetween, and an electrical resistance between the pair of detection electrodes 3a and 3b (hereinafter referred to as inter-detection-electrode resistance Rs as appropriate) varies according to the deposition amount of particulate matter.

The temperature compensation unit 4 includes a temperature compensation conductive layer 2b that is composed of the same conductive material as that of the detection conductive layer 2a and has a non-deposition surface 41 arranged at a position at which no particulate matter is deposited, and a pair of temperature compensation electrodes 4a and 4b that are arranged on the non-deposition surface 41. The pair of temperature compensation electrodes 4a and 4b face each other with a part of the non-deposition surface 41 interposed therebetween, and temperature compensate an output of the PM detection unit 3.

In the PM detection unit 3, the pair of detection electrodes 3a and 3b are connected to the first output terminal 11 and the common ground terminal 13, respectively. In the temperature compensation unit 4, the pair of temperature compensation electrodes 4a and 4b are connected to the second output terminal 12 and the common ground terminal 13, respectively.

The conductive material for forming the detection conductive layer 2a and the temperature compensation conductive layer 2b will be described later in detail.

The sensor control unit 5 includes the detection control unit 50 including a detection circuit unit 51 and a particulate matter amount calculation unit (hereinafter referred to as PM amount calculation unit) 52, and the heater control unit 60.

The detection circuit unit 51 is connected to the first output terminal 11 and outputs a first output signal (hereinafter referred to as PM detection signal Va) based on the inter-detection-electrode resistance Rs. Furthermore, the detection circuit unit 51 is connected to the second output terminal 12 and detects a second output signal (hereinafter referred to as temperature compensation signal Vb) based on an electrical resistance between the pair of temperature compensation electrodes 4a and 4b of the temperature compensation unit 4 (hereinafter referred to as inter-compensation-electrode resistance Rb as appropriate).

The PM amount calculation unit 52 calculates the deposition amount of particulate matter on the basis of a differential output V1 between the PM detection signal Va and the temperature compensation signal Vb that are detected by the detection circuit unit 51.

The heater control unit 60 outputs a control signal to the heater unit 6 incorporated in the sensor element 10, and supplies power to a heater electrode 61 to heat the sensor element 10 to a predetermined temperature. For example, prior to the detection of particulate matter, the heater unit 6 is operated to combust and remove the particulate matter deposited on the deposition surface 31 of the PM detection unit 3. Thus, the sensor element 10 can be regenerated.

The components of the sensor control unit 5 will be described later in detail.

Next, the configuration of the sensor element 10 will be described in detail.

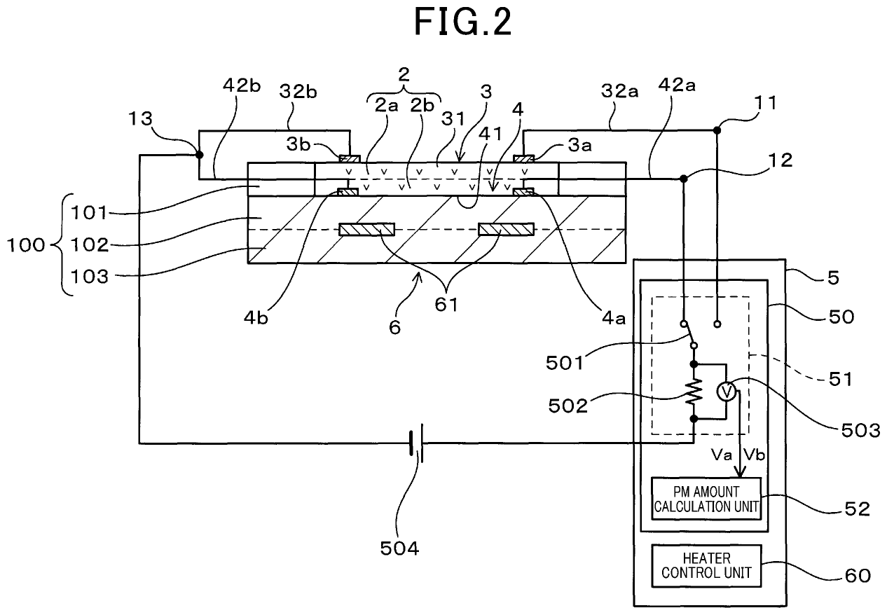

As shown in FIGS. 1 and 2, the sensor element 10 includes the PM detection unit 3, the temperature compensation unit 4, the heater unit 6, and an insulating substrate 100. The insulating substrate 100 is composed of insulating plates 101 to 103 having a rectangular plate shape. The PM detection unit 3, the temperature compensation unit 4, and the heater unit 6 are arranged on the same side (e.g., upper surface side of FIG. 1) of the insulating plates 101 to 103, respectively, and laminated in this order with the insulating plates 101 to 103 interposed therebetween. Thus, the PM detection unit 3, the temperature compensation unit 4, and the heater unit 6 are integrated with the insulating substrate 100 to form the sensor element 10.

The insulating plates 101 to 103 constituting the insulating substrate 100 are composed, for example, of an insulating ceramic material such as alumina.

Hereinafter, a longitudinal direction and a width direction of the insulating substrate 100 are referred to as a longitudinal direction X and a width direction Y of the sensor element 10, and a lamination direction of the insulating substrate 100 is referred to as a lamination direction Z of the sensor element 10.

The insulating substrate 100 is composed of the two insulating plates 102 and 103 having substantially the same shape and the insulating plate 101 having a shorter length in the longitudinal direction X than the insulating plates 102 and 103. The insulating plates 101 to 103 are arranged so that a base end side (e.g., right end side of FIG. 1) in the longitudinal direction X of the insulating plates 101 to 103 are aligned. On the base end side, the first output terminal 11 and the second output terminal 12 are provided on a surface of the insulating plate 101 which is an upper surface of the insulating substrate 100, and the ground terminal 13 and a heater terminal 14 are provided on a surface of the insulating plate 103 which is a lower surface of the insulating substrate 100.

In the sensor element 10, the detection conductive layer 2a and the temperature compensation conductive layer 2b are provided in contact with a tip end side (e.g., left end side of FIG. 1) in the longitudinal direction X of the insulating plate 101 which is a side opposite to the base end side.

In the PM detection unit 3, a surface of the detection conductive layer 2a which is an uppermost surface on the tip end side of the sensor element 10 is the deposition surface 31 that is exposed to measured gas. On the deposition surface 31, the pair of detection electrodes 3a and 3b are arranged to face each other with a predetermined space therebetween in the width direction Y. The detection electrodes 3a and 3b are each a linear electrode extending in the longitudinal direction X, and are connected to the first output terminal 11 and the ground terminal 13 via a pair of lead units 32a and 32b extending in the longitudinal direction X, respectively.

The temperature compensation unit 4 includes the temperature compensation conductive layer 2b that is arranged between the detection conductive layer 2a and the insulating plate 102. A surface on the insulating plate 102 side (i.e., lower surface side) of the temperature compensation conductive layer 2b is the non-deposition surface 41. On the non-deposition surface 41, the pair of temperature compensation electrodes 4a and 4b are arranged to face each other with a predetermined space therebetween in the width direction Y. The temperature compensation electrodes 4a and 4b are each a linear electrode extending in the longitudinal direction X, and are connected to the second output terminal 12 and the ground terminal 13 via a pair of lead units 42a and 42b extending in the longitudinal direction X, respectively.

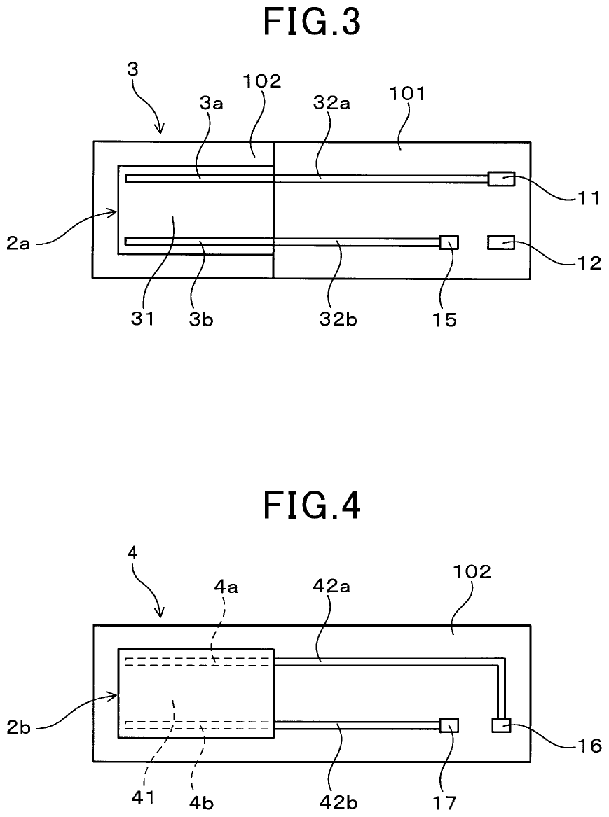

As shown in FIG. 3, the pair of detection electrodes 3a and 3b formed on the upper surface of the detection conductive layer 2a extend from the tip end side toward a base end edge of the detection conductive layer 2a and are connected to the pair of lead units 32a and 32b formed on the upper surface of the insulating plate 101, respectively. The lead 32a connected to the detection electrode 3a extends from a tip end edge toward a base end portion of the insulating plate 101 and is connected to the first output terminal 11. The lead unit 32b connected to the detection electrode 3b extends from the tip end edge toward the base end side of the insulating plate 101 and is connected to a conductive portion 15 for terminal extraction.

As shown in FIG. 4, the temperature compensation conductive layer 2b is arranged to entirely cover the pair of temperature compensation electrodes 4a and 4b formed on an upper surface on the tip end side of the insulating plate 102. The pair of temperature compensation electrodes 4a and 4b are connected to the pair of lead units 42a and 42b, respectively, at a base end edge of the temperature compensation conductive layer 2b. The lead unit 42a connected to the temperature compensation electrode 4a extends toward the base end side of the insulating plate 102 and is connected to a conductive portion 16 for terminal extraction. The lead unit 42b connected to the temperature compensation electrode 4b extends toward the base end side of the insulating plate 102 and is connected to a conductive portion 17 for terminal extraction.

In FIG. 1, the heater unit 6 is composed of the heater electrode 61 formed on an upper surface on the tip end side of the insulating plate 103, and a pair of lead units 62a and 62b that are connected to both ends of the heater electrode 61 and extend toward the base end side of the insulating plate 103. At a base end portion of the insulating plate 103, the lead unit 62a is connected to a conductive portion 18 for terminal extraction, and the lead unit 62b is connected to a conductive portion 19 for terminal extraction. The conductive portion 18 is connected to the heater terminal 14 formed on the lower surface of the insulating plate 103, and the conductive portion 19 passes through the insulating plate 103 and is connected to the ground terminal 13 formed on the lower surface of the insulating plate 103.

The conductive portions 15 and 17 pass through the same position in the lamination direction Z on the insulating plates 101 and 102, respectively, and are connected to a conductive portion 19a provided at a part of the lead unit 62b. Thus, the detection electrode 3b of the PM detection unit 3, the temperature compensation electrode 4b of the temperature compensation unit 4, and one end of the heater electrode 61 of the heater unit 6 are electrically connected to the common ground terminal 13 via the conductive portion 19. The temperature compensation electrode 4a of the temperature compensation unit 4 is connected to the second output terminal 12 formed on the upper surface of the insulating plate 101 via the conductive portion 16.

In this case, the detection electrodes 3a and 3b and the temperature compensation electrodes 4a and 4b are formed to have substantially the same shape. The detection electrodes 3a and 3b with the detection conductive layer 2a interposed therebetween and the temperature compensation electrodes 4a and 4b with the temperature compensation conductive layer 2b interposed therebetween are symmetrically arranged to be located at positions overlapping in the lamination direction Z. The lead units 32a and 32b of the detection electrode 31 are located at positions overlapping with those of the lead units 32a and 32b of the temperature compensation electrode 41 in the lamination direction Z, and insulated from the lead units of the temperature compensation electrode by the insulating plate 101.

In FIG. 2, the detection conductive layer 2a and the temperature compensation conductive layer 2b are arranged adjacent to each other on the same side of the insulating substrate 100 and integrally laminated to form a conductive layer 2. The conductive layer 2 is laminated on the insulating substrate 100 so that a portion of the conductive layer 2 on the deposition surface 31 side is exposed. In this case, the deposition surface 31 and the pair of detection electrodes 3a and 3b formed on the deposition surface 31 are exposed to measured gas. The non-deposition surface 41 on a side opposite to the deposition surface 31 and the pair of temperature compensation electrodes 4a and 4b formed on the non-deposition surface 41 are embedded inside the sensor element 10 and are not exposed to measured gas.

The detection circuit unit 51 of the detection control unit 50 includes a switch 501, a shunt resistor 502, a voltage measurement unit 503, and a DC power supply 504. A negative electrode terminal of the DC power supply 504 is connected to the ground terminal 13 of the sensor element 10. The switch 501 is configured to connect a positive electrode terminal of the DC power supply 504 to one of the first output terminal 11 and the second output terminal 12. Thus, by switching the switch 501, a voltage (e.g., VB) of the DC power supply 504 can be applied to either the pair of detection electrodes 3a and 3b of the PM detection unit 3 or the pair of temperature compensation electrodes 4a and 4b of the temperature compensation unit 4.

In this case, an electric current I that has flowed between the pair of detection electrodes 3a and 3b or between the pair of temperature compensation electrodes 4a and 4b passes through the shunt resistor 502. By measuring a voltage drop due to the shunt resistor 502 using the voltage measurement unit 503, it is possible to measure the electric current I and calculate an electrical resistance (=VB/I) between the electrodes.

The detection control unit 50 switches the switch 501 of the detection circuit unit 51 to the PM detection unit 3 side, and causes the voltage measurement unit 503 to measure an electric current Is based on the inter-detection-electrode resistance Rs and causes the electric current Is to be outputted as the PM detection signal Va. Furthermore, the detection control unit 50 switches the switch 501 to the temperature compensation unit 4 side, and causes the voltage measurement unit 503 to measure an electric current Ib based on the inter-compensation-electrode resistance Rb and causes the electric current Ib to be outputted as the temperature compensation signal Vb.

The PM amount calculation unit 52 of the detection control unit 50 subtracts the temperature compensation signal Vb from the PM detection signal Va to obtain the differential output V1, and calculates the amount of PM by using the differential output V1. Thus, the PM amount calculation unit 52 corrects the PM detection signal Va that varies according to the amount of PM deposition by using the temperature compensation signal Vb for temperature compensation and noise removal, and calculates the amount of PM on the basis of the corrected signal, thereby improving detection accuracy.

As described above, the detection conductive layer 2a and the temperature compensation conductive layer 2b are composed of a conductive material. Thus, as shown in FIG. 5, even in a state in which no particulate matter is deposited at all on the deposition surface 31, the electric current I can flow through the detection conductive layer 2a and the temperature compensation conductive layer 2b. A space Wa between the pair of detection electrodes 3a and 3b is equal to a space Wb between the pair of temperature compensation electrodes 4a and 4b, and lengths in the longitudinal direction X of the electrodes are equal to each other. Thus, a detection conductive layer resistance Ra which is the inter-detection-electrode resistance Rs when no particulate matter is deposited is approximately equal to the inter-compensation-electrode resistance Rb, and an electric current Ia flowing between the pair of detection electrodes 3a and 3b is approximately equal to the electric current Ib flowing between the pair of temperature compensation electrodes 4a and 4b.

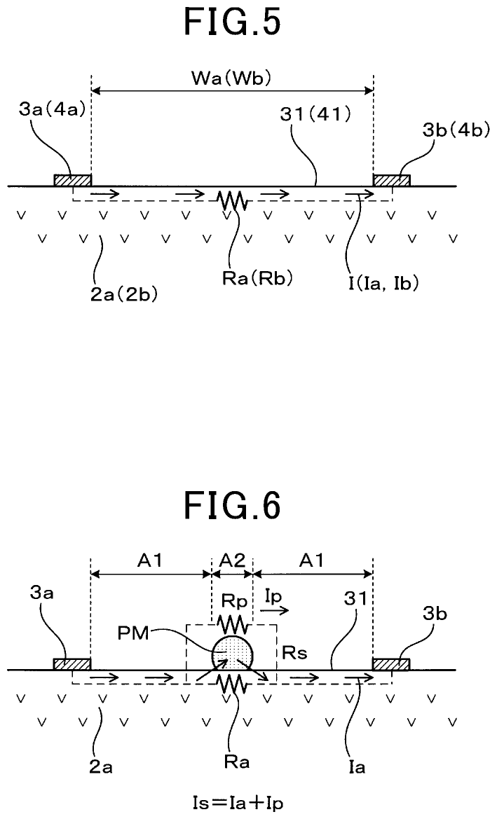

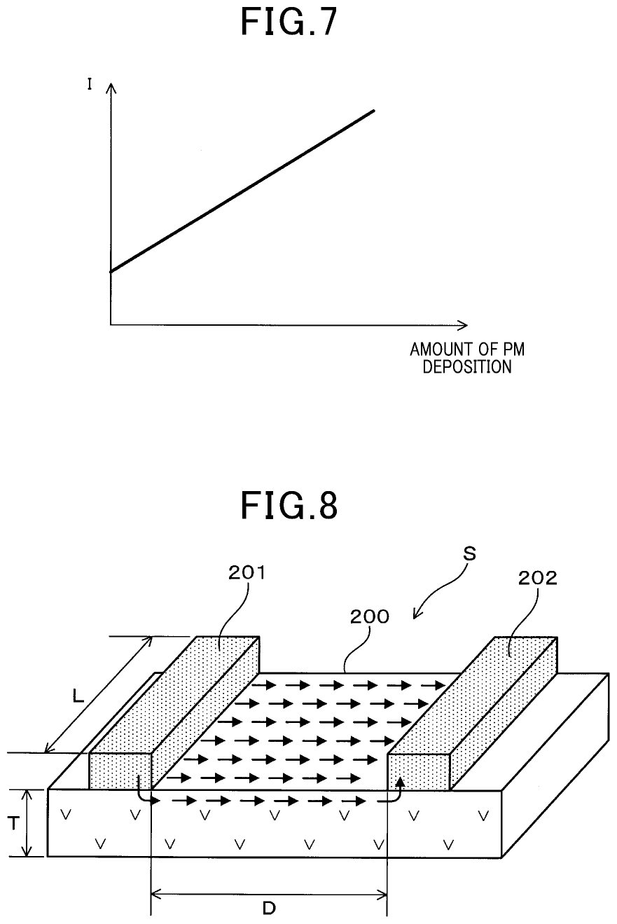

Next, as shown in FIG. 6, when a small amount of particulate matter (i.e., PM shown in FIG. 6) is deposited on the deposition surface 31 of the PM detection unit 3, in a region A1 of the deposition surface 31 in which no PM is deposited, the electric current I flows through the detection conductive layer 2a (i.e., electric current Ia), and in a region A2 in which PM is deposited, the electric current I mainly flows through the PM having a low electrical resistivity (i.e., PM current Ip). Thus, as shown in FIG. 7, even when a small amount of PM is attached to the deposition surface 31, the electric current I varies and increased in proportion to the amount of PM deposition. The amount of PM deposition can be calculated by detecting the change in the electric current I.

In FIG. 6, a value of the inter-detection-electrode resistance Rs is determined by the detection conductive layer resistance Ra and an electrical resistance Rp of the deposited particulate matter (hereinafter referred to as PM resistance as appropriate). The inter-detection-electrode resistance Rs can be approximately expressed, for example, by the following equation 1.

Rs=RpRa/(Rp+Ra) Equation 1

Since Ra=Rb, equation 1 can be transformed to the following equation 11.

Rs=RpRb/(Rp+Rb) Equation 11

From equation 11, the PM resistance Rp can be calculated by measuring Rs and Rb, and by using a relationship between the PM resistance Rp and the amount of PM deposition, the amount of PM deposition can be calculated.

Alternatively, the amount of PM deposition can be calculated, for example, in the following manner.

The electric current Is flowing between the pair of detection electrodes 3a and 3b of the PM detection unit 3 can be approximately expressed by the following equation 2 using the electric current Ia flowing through the detection conductive layer 2a and the PM current Ip.

Is=Ia+Ip Equation 2

Since Ia=Ib, equation 2 can be transformed to the following equation 21.

Is=Ib+Ip Equation 21

From equation 21, the PM current Ip can be expressed by the following equation 3.

Ip=Is−Ib Equation 3

As described above, sensor outputs corresponding to the electric currents Is and Ib can be obtained by using the detection circuit unit 51. Thus, by calculating a difference between the sensor outputs and using a relationship between the calculated difference and the amount of PM deposition, the amount of PM deposition can be calculated.

The PM current Ip calculated by equation 3 is a value obtained by subtracting the electric current Ia flowing through the detection conductive layer 2a (i.e., the electric current Ib flowing through the temperature compensation conductive layer 2b) from the electric current Is flowing between the pair of detection electrodes 3a and 3b of the PM detection unit 3. The detection conductive layer 2a and the temperature compensation conductive layer 2b constitute the integrated conductive layer 2 and are in an equivalent temperature environment. Furthermore, the detection electrode 3b of the PM detection unit 3 and the temperature compensation electrode 4b of the temperature compensation unit 4 are connected to the common ground terminal 13. Thus, the influence of noise due to a measurement environment is equivalent on the detection electrode 3b and the temperature compensation electrode 4b.

Therefore, by subtracting the electric current Ia from the electric current Is, it is possible to calculate the PM current Ip from which the influence of temperature and noise is eliminated.

The conductive material for forming the detection conductive layer 2a and the temperature compensation conductive layer 2b will be described below. The detection conductive layer 2a and the temperature compensation conductive layer 2b are composed of a conductive material having a higher electrical resistivity than the particulate matter. The conductive material preferably has a surface electrical resistivity, for example, in the range of 1.0×10⁷ to 1.0×10¹⁰ Ω·cm in the temperature range of 100 to 500° C. The conductive material having a surface electrical resistivity in the above numerical range may be, for example, ceramics having a perovskite structure having a molecular formula of ABO₃. In the molecular formula, the A site is at least one selected from La, Sr, Ca, and Mg, and the B site is at least one selected from Ti, Al, Zr, and Y. Preferably, perovskite ceramics in which a main component of the A site is Sr and a secondary component of the A site is La, and the B site is Ti (i.e., Sr₁₋ₓLaₓTiO₃) is employed.

For example, when x in (Sr₁₋ₓLaₓTiO₃) is in the range of 0.016 to 0.036, a surface electrical resistivity ρ is in the range of 1.0×10⁷ to 1.0×10¹⁰ Ω·cm in the temperature range of 100 to 500° C. Thus, such ceramics (e.g., Sr_{0.984}La_{0.016}TiO₃, Sr_{0.98}La_{0.02}TiO₃, Sr_{0.964}La_{0.036}TiO₃) can be suitably used as the material for forming the conductive layer 2.

The “surface electrical resistivity ρ” means a value obtained by preparing a sample S shown in FIG. 8, measuring an electrical resistance between measurement electrodes 201 and 202, and performing calculation using the following equation 4.

In the present embodiment, the surface electrical resistivity ρ of a conductive material is measured in the following manner. Specifically, first, the sample S shown in FIG. 8 is prepared. The sample S includes a plate-like substrate 200 that is composed of a conductive material and has a thickness T of 1.4 mm, and the pair of measurement electrodes 201 and 202 that are formed on a main surface of the plate-like substrate 200, have a length L, and are spaced from each other by a space D. In the formed sample S, an electrical resistance R (unit: Ω) between the pair of measurement electrodes 201 and 202 is measured. The surface electrical resistivity ρ is calculated by the following equation 4.

ρ=R×L×T/D Equation 4

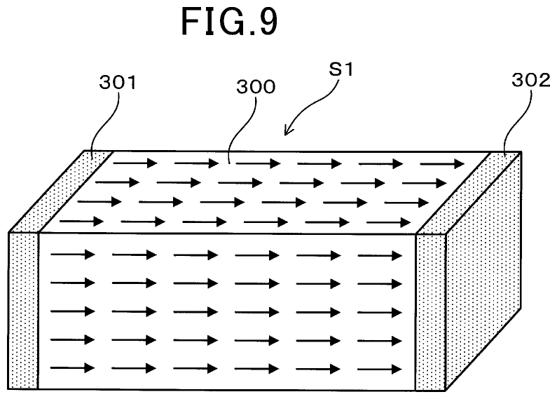

The term “electrical resistivity” herein refers to what is called bulk electrical resistivity. For example, as shown in FIG. 9, the bulk electrical resistivity can be calculated by preparing a bulk sample S1 including a substrate unit 300 that is composed of a conductive material and a pair of measurement electrodes 301 and 302 that are formed on side surfaces of the substrate unit 300, and measuring an electrical resistance between the pair of measurement electrodes 301 and 302.

The electrical resistivity of particulate matter can be measured by the following powder resistance measurement method. Specifically, a powder (PM) is placed in a predetermined cylindrical container (cross-sectional area: A) whose bottom surface and upper surface are electrode plates, and while pressure is applied from above to the electrode plate of the upper surface to compress the powder (PM) in a longitudinal axis direction, a distance L between the electrodes and an electrical resistance R between the electrodes are measured. In this measurement method, the electrical resistivity ρ of the powder (PM) is calculated by R×(A/L).

For example, when a cylindrical container having a cross section of 6 mmφ (cross-sectional area: 2.83×10⁻⁵ m²) is used and the electrical resistance R is measured while a pressure of 60 kgf is applied to the container, the electrical resistivity of the PM is specifically in the range of 1.0×10⁻³ to 1.0×10² Ω·cm. The electrical resistivity of generated PM varies according to an operating condition of the engine. For example, in the case of PM that is discharged in an operating condition with high load and high rotation speed, contains a small amount of unburned hydrocarbon component, and is mostly composed of soot, the PM has an electrical resistivity of approximately 10⁻³ Ω·cm. In the case of PM that is discharged from an engine in an operating condition with low rotation speed and low load, contains a large amount of unburned hydrocarbon component, and has the highest resistivity, the PM has an electrical resistivity of approximately 1.0×10² Ω·cm.

Thus, the detection conductive layer 2a and the temperature compensation conductive layer 2b of the present embodiment preferably have an electrical resistivity of at least 1.0×10² Ω·cm or more.

A space H in the lamination direction Z between the temperature compensation electrodes 4a and 4b and the detection electrodes 3a and 3b, that is, a thickness of the conductive layer 2 is preferably determined so that while the pair of detection electrodes 3a and 3b are covered with particulate matter, a ratio Ib/Is between the electric current Ib flowing between the pair of temperature compensation electrodes 4a and 4b and the electric current Is flowing between the pair of detection electrodes 3a and 3b may be 0.02 or less.

This is because if the space H is small, the temperature compensation electrodes 4a and 4b are located close to the deposition surface 31, and thus the electric current Ib passes through the particulate matter having a low electrical resistivity and flows between the pair of temperature compensation electrodes 4a and 4b. When the space H is large, the temperature compensation electrodes 4a and 4b are located far from the deposition surface 31, and thus the electric current Ib is less likely to flow through the particulate matter and the electric current Ib has a small value. It has been experimentally confirmed that in order to obtain this effect, the ratio Ib/Is is preferably 0.02 or less. In that case, even when a manufacturing variation occurs in the thickness of the conductive layer 2, the electric current Ib can be accurately measured, and the inter-compensation-electrode resistance Rb can be accurately measured. Thus, a change in the detection conductive layer resistance Ra according to the temperature can be accurately compensated.

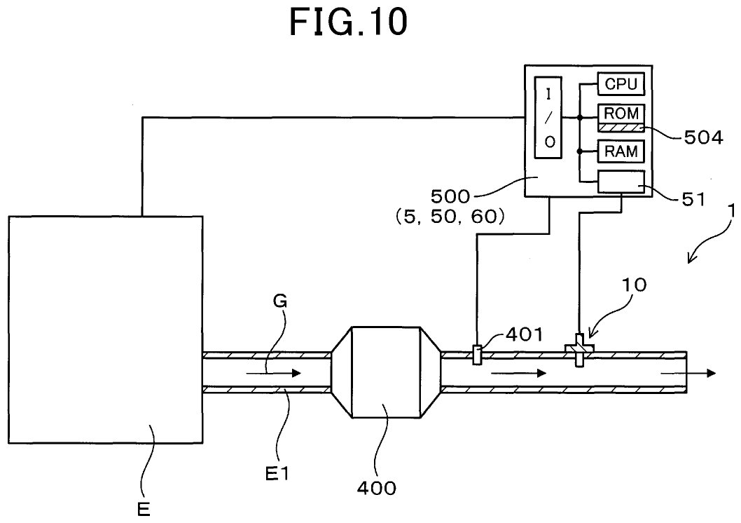

As shown in FIG. 10, the particulate matter detection device 1 of the present embodiment is applied, for example, to an exhaust gas purification system of an automobile engine E, and detects the amount of particulate matter contained in exhaust gas G which is measured gas. In an exhaust gas pipe E1 connected to the engine E, a particulate filter 400 for collecting the particulate matter is arranged. The sensor element 10 is arranged downstream of the particulate filter 400, and is mounted and fixed to a wall of the exhaust gas pipe E1 so that a half portion on the tip end side of the sensor element 10 housed in an element cover (not shown) is located in the exhaust gas pipe E1. An exhaust gas temperature sensor 401 is placed between the particulate filter 400 and the sensor element 10 to detect an exhaust gas temperature downstream of the particulate filter 400.

The sensor element 10 is connected to an engine control unit (hereinafter referred to as ECU) 500 that constitutes the sensor control unit 5. The ECU 500 includes a CPU that performs arithmetic processing, a ROM that stores programs, data, and the like, a RAM, an input/output port I/O, and the like, and controls the entire system including the particulate matter detection device 1 by periodically executing the programs. The ROM stores a program 504 corresponding to the detection control unit 50 of the sensor control unit 5 and the heater control unit 60. When the CPU reads and executes the program 504, the amount of PM deposited on the sensor element 10 is measured. The measured value can be used to perform fault diagnosis of the particulate filter 400.

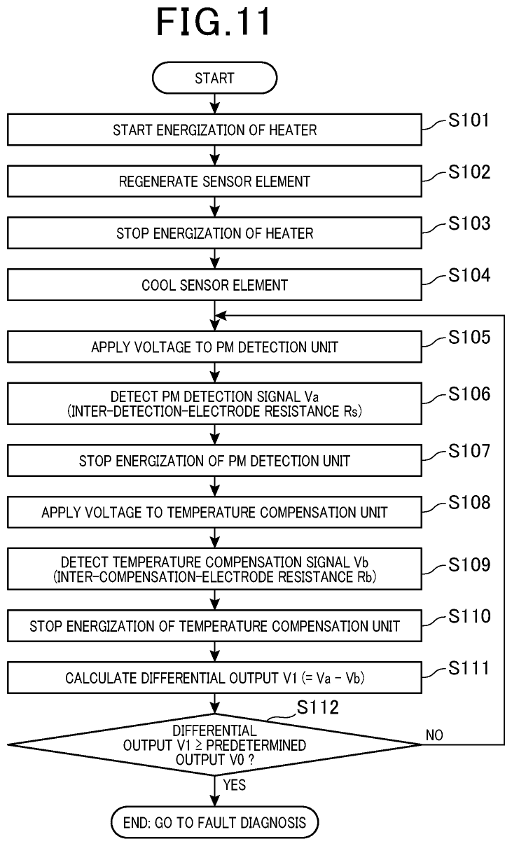

Next, a particulate matter detection process performed by the sensor control unit 5 will be described with reference to a flow chart shown in FIG. 11.

First, a step S101, in order to perform a regeneration process of the sensor element 10 prior to the detection of the amount of PM deposition, energization of the heater unit 6 is started by using the heater control unit 60. Thus, at step S102, the heater unit 6 generates heat and regenerates the sensor element 10. The regeneration process is a process for combustion removal of the particulate matter attached to the deposition surface 31 of the sensor element 10 in advance, and the regeneration temperature is usually set to 600° C. or more that allows combustion removal of soot.

When a predetermined regeneration process time has elapsed, at step S103, the energization of the heater unit 6 is stopped, and at subsequent step S104, the sensor element 10 is allowed to cool for a predetermined standby time. When the regeneration process is complete, at step S105 and the subsequent steps, the detection of the amount of PM deposition is started by using the detection control unit 50.

At step S105, the switch 501 of the detection circuit unit 51 is switched to the PM detection unit 3 side, and a predetermined voltage is applied between the pair of detection electrodes 3a and 3b. Thus, an electrostatic field is formed in the PM detection unit 3 and deposition of particulate matter on the deposition surface 31 is promoted.

Next, at step S106, the PM detection signal Va based on the inter-detection-electrode resistance Rs is detected. Then, at step S107, the energization of the pair of detection electrodes 3a and 3b of the PM detection unit 3 is stopped.

At step S108, the switch 501 of the detection circuit unit 51 is switched to the temperature compensation unit 4 side, and a predetermined voltage is applied between the pair of temperature compensation electrodes 4a and 4b. Next, at step S109, the temperature compensation signal Vb based on the inter-compensation-electrode resistance Rb is detected. Then, at step S110, the energization of the pair of temperature compensation electrodes 4a and 4b of the temperature compensation unit 4 is stopped.

At step S111, the PM amount calculation unit 52 calculates the differential output V1 by using the PM detection signal Va and the temperature compensation signal Vb (i.e., V1=Va−Vb). Next, at step S112, it is determined whether the differential output V1 has reached a predetermined output V0(V1≥V0?). The predetermined output V0 which serves as a threshold is used, for example, as a detection reference for fault diagnosis of the particulate filter 400, and may be an output value corresponding to the minimum detectable amount of PM deposition.

When a negative determination is made at step S112, control returns to step S105, and step S105 and the subsequent steps are repeated. When an affirmative determination is made at step S112, the process is ended, and control proceeds to a process for fault diagnosis. For example, when a time t required for the differential output V1 to reach the predetermined output V0 is shorter than a predetermined upper limit value, the particulate filter 400 is determined to be in failure, and when the time t is longer than the upper limit value, the particulate filter 400 is determined to be not in failure.

Next, advantageous effects of the present embodiment will be described.

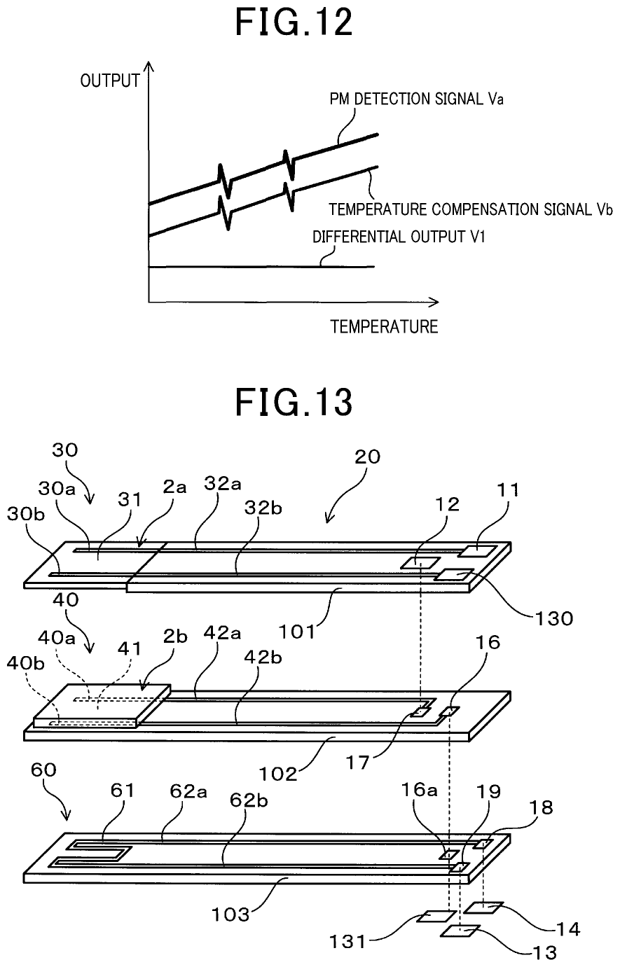

FIG. 12 shows the influence of the measurement environment on the output of the sensor element 10 of the particulate matter detection device 1 of the present embodiment, and the PM detection signal Va and the temperature compensation signal Vb outputted from the detection circuit unit 51 show an approximately equivalent change over time. In this case, the amount of PM deposition in the PM detection unit 3 is constant.

In FIG. 12, the gradients of the PM detection signal Va and the temperature compensation signal Vb are influenced by a change in temperature of the measurement environment, and caused by a characteristic of the detection conductive layer 2a of the PM detection unit 3 and the temperature compensation conductive layer 2b of the temperature compensation unit 4 in which the electrical resistance varies according to the temperature. In this case, the output is also increased together with the increase in the temperature. However, in the detection conductive layer 2a and the temperature compensation conductive layer 2b having the equivalent temperature characteristic, the gradient of the output is also equivalent.

Depending on the measurement environment, in some cases, noise enters a signal line and causes output variation. However, since the pair of detection electrodes 3a and 3b and the pair of temperature compensation electrodes 4a and 4b are connected to the common ground terminal 13, the timing and magnitude of the output variation due to the noise are equivalent.

As a result, in the PM detection signal Va and the temperature compensation signal Vb, the timing and the magnitude are substantially the same not only in the output change according to the temperature but also in the output variation due to the noise, and thus the differential output V1 between the PM detection signal Va and the temperature compensation signal Vb is approximately constant. In the present embodiment, since the heater electrode 61 of the heater unit 6 is also connected to the common ground terminal 13, the influence of noise due to operation of the heater unit 6 or the like can also be eliminated. By performing the regeneration process by the heater unit, detection of the PM detection signal Va, and detection of the temperature compensation signal Vb at different timings, the influence of noise based on these operations can also be prevented.

Thus, by storing in advance a relationship between the differential output V1 and the amount of PM deposition, the amount of PM deposition can be accurately detected.

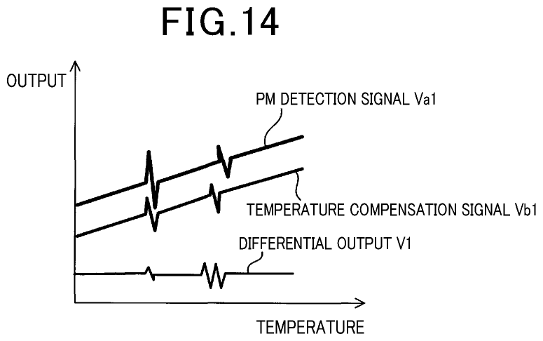

On the other hand, when a sensor element 20 for comparison shown in FIG. 13 is used, as shown in FIG. 14, the influence of noise is not eliminated. In FIG. 13, the sensor element 20 for comparison differs from the sensor element 10 only in that the sensor element 20 includes a PM detection unit 30, a temperature compensation unit 40, and a heater unit 60, and the sensor element 20 includes a plurality of ground terminals 13, 130, and 131 connected to electrodes of the components, respectively.

Specifically, a pair of detection electrodes 30a and 30b of the PM detection unit 30 are connected to the first output terminal 11 and the ground terminal 130 formed on the upper surface of the insulating plate 101 via the lead units 32a and 32b, respectively. A pair of temperature compensation electrodes 40a and 40b of the temperature compensation unit 40 are connected to the second output terminal 12 formed on the upper surface of the insulating plate 101 and the ground terminal 131 formed on the lower surface of the insulating plate 103 via the lead units 42a and 42b and the conductive portions 17 and 16, respectively. A conductive portion 16a for connecting the conductive portion 16 to the ground terminal 131 is formed on the insulating plate 103. The heater unit 60 has the same configuration as that of the heater unit 6 of the sensor element 10.

In this case, as shown in FIG. 14, in a PM detection signal Va1 and a temperature compensation signal Vb1 based on the sensor element 20 for comparison, the gradients due to the change in the temperature are equivalent, but noises at different timings with different magnitudes are superimposed on the outputs, thereby causing deviation of the output variation. Thus, by obtaining the differential output V1 between the PM detection signal Va1 and the temperature compensation signal Vb1, the gradient of the output is removed, but the noises cannot be completely removed.

As described above, the particulate matter detection device 1 of the present embodiment can eliminate the influence of the measurement environment and accurately detect the amount of PM deposition. Furthermore, the use of the common ground terminal can achieve a simple configuration and a reduction in manufacturing cost.

### Embodiment 2

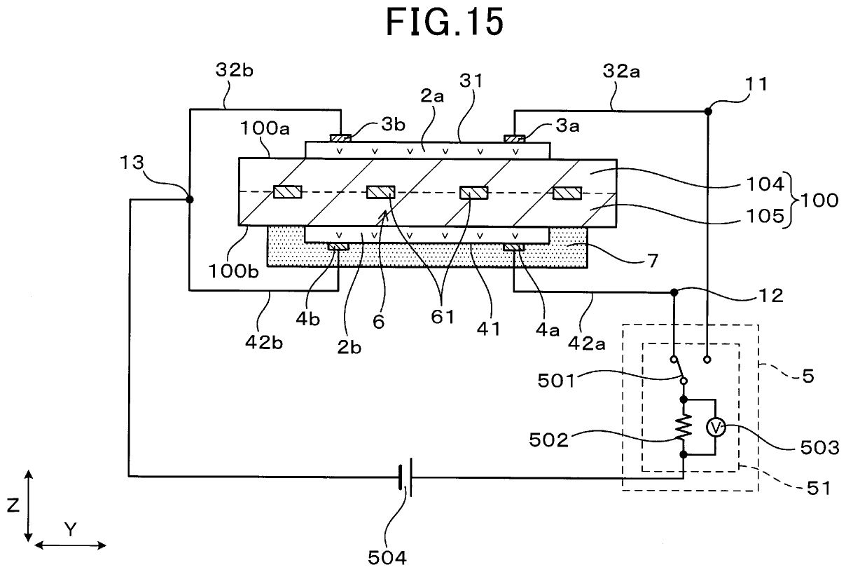

Embodiment 2 of the particulate matter detection device 1 will be described with reference to FIGS. 15 to 18. In FIG. 15, as in Embodiment 1, the particulate matter detection device 1 of the present embodiment includes the sensor element 10 and the sensor control unit 5. The sensor control unit 5 has the same configuration as that of Embodiment 1, and the components of the sensor control unit 5 other than the detection circuit unit 51 are not shown in the drawings. The present embodiment differs from Embodiment 1 in the arrangement of the sensor element 10, the PM detection unit 3, and the temperature compensation unit 4, and the differences will be mainly described below.

Of reference signs used in Embodiment 2 and subsequent embodiments, the same reference signs as those used in the previously described embodiments indicate the same components or the like as those of the previously described embodiments unless otherwise specified.

In the present embodiment, the sensor element 10 has a configuration in which the PM detection unit 3 and the temperature compensation unit 4 are arranged to face each other with the insulating substrate 100 interposed therebetween. The heater electrode 61 is incorporated in the insulating substrate 100 to form the heater unit 6. The insulating substrate 100 is composed, for example, of two insulating plates 104 and 105 having the same shape. The heater electrode 61 is sandwiched between the two insulating plates 104 and 105 and integrated with the insulating plates 104 and 105 so that the heater electrode 61 is embedded.

The PM detection unit 3 includes the detection conductive layer 2a laminated on one surface 100a of the insulating substrate 100 in the lamination direction Z, and the pair of detection electrodes 3a and 3b arranged on the deposition surface 31 of the detection conductive layer 2a. The detection electrode 3a is connected to the first output terminal 11 via the lead unit 32a, and the detection electrode 3b is connected to the common ground terminal 13 via the lead unit 32b.

The temperature compensation unit 4 includes the temperature compensation conductive layer 2b laminated on a surface 100b facing the surface 100a of the insulating substrate 100 in the lamination direction Z, and the pair of temperature compensation electrodes 4a and 4b arranged on the non-deposition surface 41 of the temperature compensation conductive layer 2b. The temperature compensation electrode 4a is connected to the second output terminal 12 via the lead unit 42a, and the temperature compensation electrode 4b is connected to the common ground terminal 13 via the lead unit 42b.

The temperature compensation unit 4 is provided with a gas-permeable insulating film 7 so that the temperature compensation conductive layer 2b and the pair of temperature compensation electrodes 4a and 4b are entirely covered with the gas-permeable insulating film 7. The gas-permeable insulating film 7 is composed of an insulating film that prevents particulate matter from passing through and has gas permeability that allows a gas component contained in exhaust gas to pass through. Thus, while preventing the particulate matter from reaching the non-deposition surface 41, exhaust gas excluding the particulate matter is allowed to reach the non-deposition surface 41, thereby allowing the non-deposition surface 41 to have a measurement environment equivalent to that of the deposition surface 31.

In the configuration of the present embodiment, the PM detection unit 3 and the temperature compensation unit 4 are symmetrically arranged with the insulating substrate 100 in which the heater unit 6 is incorporated interposed therebetween. Thus, both the detection conductive layer 2a and the temperature compensation conductive layer 2b are arranged in contact with the insulating substrate 100, and both the deposition surface 31 and the non-deposition surface 41 are arranged to be located on a side opposite to the insulating substrate 100 and exposed to exhaust gas. Therefore, a temperature characteristic in which the resistance is changed according to the temperature is equivalent in the detection conductive layer 2a and the temperature compensation conductive layer 2b.

When the exhaust gas contains, for example, acidic gases such as SO₂ or NO₂, and the detection conductive layer 2a is exposed to the acidic gas, the electrical resistance may be changed and influence the output. In the present embodiment, since the temperature compensation unit 4 is provided with the gas-permeable insulating film 7, the gas component other than the particulate matter passes through the gas-permeable insulating film 7. Thus, when the detection conductive layer 2a is exposed to the acidic gas, the temperature compensation conductive layer 2b is also exposed to the acidic gas. Therefore, a significant change in the output due to the influence of the gas component such as the acidic gas does not occur, and the amount of PM deposition can be accurately detected.

The gas-permeable insulating film 7 is composed, for example, of an oxide insulating material such as porous ceramics that has a large number of communication holes with a smaller average particle size than the particulate matter to be measured. Alternatively, the gas-permeable insulating film 7 may be composed of an oxide insulating material such as a solid electrolyte that ionizes the gas component and allows the gas component to pass through. In this case, the gas-permeable insulating film 7 does not need to be porous, and may be a dense film. In this manner, it is possible to reliably prevent the particulate matter from reaching the non-deposition surface 41 of the temperature compensation unit 4.

Also, in the configuration of the present embodiment, as in Embodiment 1, the sensor control unit 5 can calculate the differential output V1 and calculate the amount of PM deposition.

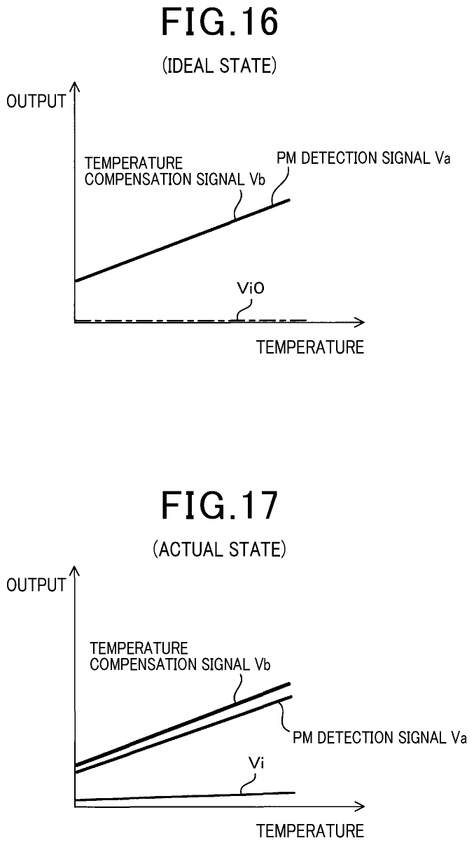

In order to more accurately calculate the amount of PM deposition, the detection control unit 50 can correct the differential output V1 by using a difference between output signals in an initial state. As shown in FIG. 16, in an ideal output state, the PM detection signal Va and the temperature compensation signal Vb are exactly the same in the initial state in which no particulate matter is deposited, and a difference Vi0 between the PM detection signal Va and the temperature compensation signal Vb is zero and unchanged. In order to achieve the ideal output state, the detection conductive layer 2a of the PM detection unit 3 and the temperature compensation conductive layer 2b of the temperature compensation unit 4 need to exhibit the same electrical resistance characteristic, and the output of the PM detection unit 3 and the output of the temperature compensation unit 4 need to match.

However, as shown in FIG. 17, in an actual output state, even in the initial state, the PM detection signal Va and the temperature compensation signal Vb are not exactly the same and are slightly different from each other in some cases. Thus, an initial difference correction value Vdi is set on the basis of an initial difference Vi between the outputs in the initial state, and the differential output V1 is corrected by using the initial difference correction value Vdi. The initial difference correction value Vdi can be stored, for example, as an initial difference map obtained before the detection of PM by preparing temperature characteristic data that defines a relationship between the initial difference Vi between the outputs and the temperature obtained by measurement in advance. Alternatively, the initial difference correction value Vdi can be stored as an initial difference correction formula by using a difference correction formula obtained from the temperature characteristic data on the difference between the outputs.

Alternatively, when the difference between the outputs has a small temperature dependence, for example, the initial difference correction value Vdi can be set as a fixed value by using a difference value at a reference temperature, an average difference value in a typical temperature range, or the like.

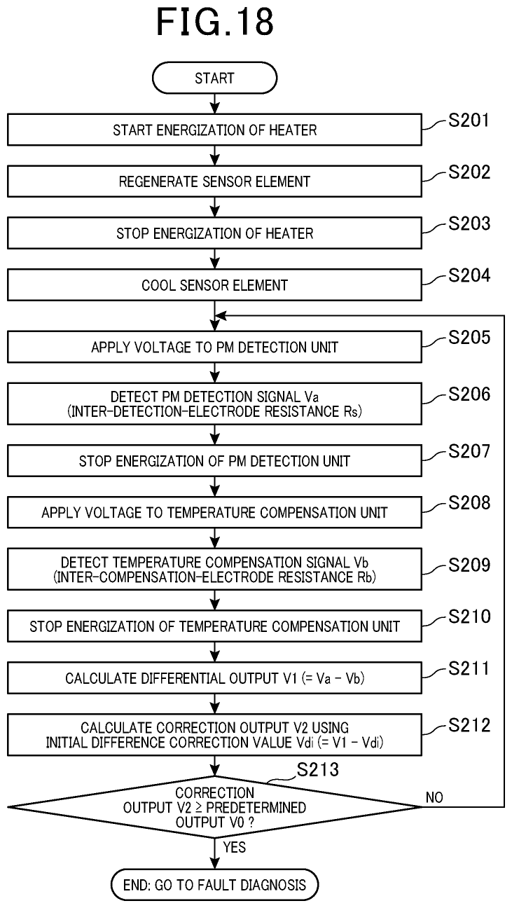

A particulate matter detection process performed by the sensor control unit 5 in this case will be described. A flow chart shown in FIG. 18 is obtained by changing part of the procedure of the flow chart shown in FIG. 11. Specifically, steps S201 to S211 are the same as steps S101 to S111 in FIG. 11, and are thus simply described, and step S212 and the subsequent steps which are the differences from the steps of the flow chart in FIG. 11 will be mainly described.

First, at steps S201 to 203, energization of the heater unit 6 is started, the regeneration process of the sensor element 10 is performed, and then the energization of the heater unit 6 is stopped. At subsequent step S204, the sensor element 10 is cooled. Subsequently, at steps S205 to S207, the PM detection unit 3 is energized, the PM detection signal Va based on the inter-detection-electrode resistance Rs is detected, and then the energization is stopped.

At steps S208 to S210, the temperature compensation unit 4 is energized, the temperature compensation signal Vb based on the inter-compensation-electrode resistance Rb is detected, and then the energization is stopped. Next, at step S211, the temperature compensation signal Vb is subtracted from the PM detection signal Va to calculate the differential output V1.

Next, at step S212, the initial difference correction value Vdi is subtracted from the differential output V1 to calculate a correction output V2 (i.e., V2=V1−Vdi). As described above, the initial difference correction value Vdi can be stored in advance as the initial difference map or the initial difference correction formula for a relationship between the initial difference Vi between the outputs and the temperature in the initial state. The temperature of the sensor element 10 can be detected or estimated, for example, by using the exhaust gas temperature sensor 401 arranged on the upstream side of the sensor element 10. Then, the initial difference correction value Vdi can be calculated by reading a map value corresponding to the detected or estimated temperature and setting the map value as the initial difference correction value Vdi, or calculated by using the initial difference correction formula.

At step S213, it is determined whether the correction output V2 obtained by the correction using the initial difference correction value Vdi has reached the predetermined output V0 (V2≥V0?). When a negative determination is made at step S213, control returns to step S205, and step S205 and the subsequent steps are repeated. When an affirmative determination is made at step S213, the process is ended, and control proceeds to the process for fault diagnosis.

Thus, even when a difference is present between the outputs in the initial state due to some influence, by performing the correction using the difference, the amount of PM deposition can be more accurately calculated. Also, in the configuration of Embodiment 1, the particulate matter detection process of the present embodiment can achieve the same effect.

### Embodiment 3

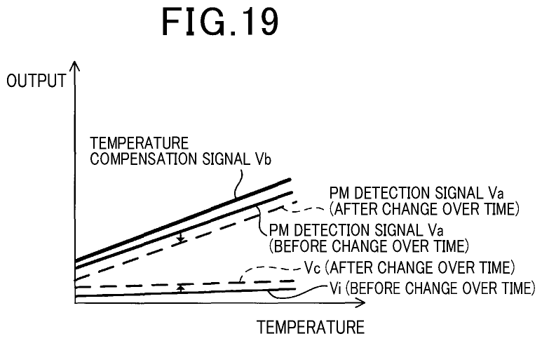

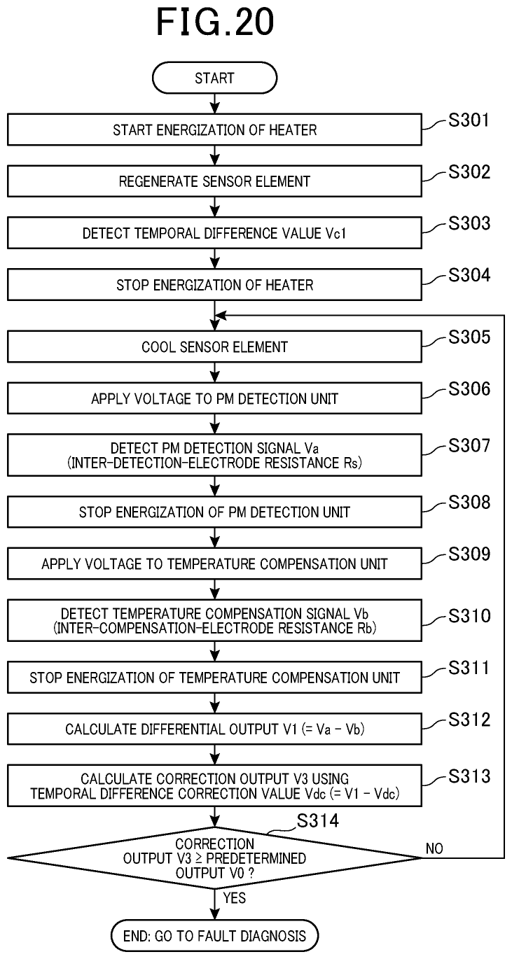

Embodiment 3 of the particulate matter detection device 1 will be described with reference to FIGS. 19 to 20. The particulate matter detection device 1 of the present embodiment has the same basic configuration as that of the particulate matter detection device 1 of the above embodiments, and differs from the particulate matter detection device 1 of the above embodiments in the method of correcting the differential output V1 after the calculation of the differential output V1 by the detection control unit 50 of the sensor control unit 5. Embodiment 2 uses the initial difference correction value Vdi based on the initial difference Vi in the initial state. However, the present embodiment uses a temporal difference correction value Vdc obtained by correction considering a temporal difference Vc after a change over time.

The differences will be mainly described below.

As shown in FIG. 19, when time has elapsed from the initial state, in the PM detection unit 3, the PM detection signal Va tends to be reduced (e.g., a solid line indicates the PM detection signal Va before the change over time, and a dotted line indicates the PM detection signal Va after the change over time). Due to the deposition of an ash component or the like caused by repeating the particulate matter deposition and regeneration, deterioration over time occurs in which the output is changed by a change in the inter-detection-electrode resistance Rs. On the other hand, in the temperature compensation unit 4, no particulate matter is deposited and thus such deterioration over time is less likely to occur. Therefore, after the regeneration process is performed, the difference between the outputs is changed, and the temporal difference Vc after the change over time becomes larger than the initial difference Vi.

Thus, in the present embodiment, the temporal difference Vc is obtained, and the initial difference correction value Vi is further corrected. Specifically, a map value of the initial difference Vi can be corrected on the basis of a temporal difference value Vc1 which is a difference value between the PM detection signal Va and the temperature compensation signal Vb detected immediately after the regeneration process of the sensor element 10 is performed. Furthermore, the initial difference correction formula can be simply corrected by assuming that the gradient of the temperature characteristic for the output shown in FIG. 19 is not changed and changing the intercept of the initial difference correction formula on the basis of the detected temporal difference value Vc1.

Then, on the basis of the corrected temporal difference map or temporal difference correction formula, the temporal difference correction value Vdc considering the change over time can be set and used to correct the differential output V1.

A particulate matter detection process performed by the sensor control unit 5 in this case will be described. A flow chart shown in FIG. 20 is obtained by changing part of the procedure of the flow chart shown in FIG. 18. Specifically, steps S301 to S302 and steps S304 to S312 are the same as steps S201 to S211 in FIG. 18, and are thus simply described, and steps S303, and step S313 and the subsequent steps which are the differences from the steps of the flow chart in FIG. 18 will be mainly described.

First, at steps S301 to 302, energization of the heater unit 6 is started, and the regeneration process of the sensor element 10 is performed. Subsequently, at step S303, the temporal difference value Vc1 between the PM detection signal Va and the temperature compensation signal Vb after the change over time is calculated. Also in this case, as in the calculation of the differential output V1, the PM detection signal Va and the temperature compensation signal Vb are sequentially detected by switching the switch 501 of the detection circuit unit 51 to the PM detection unit 3 side and the temperature compensation unit 4 side.

Thus, by performing the detection while the energization of the heater unit 6 is maintained immediately after the regeneration, it is possible to accurately detect the PM detection signal Va in a state in which no particulate matter is deposited on the PM detection unit 3. Accordingly, the difference value Vc1 corresponding to the temporal difference Vc after the change over time can be accurately calculated. Therefore, the initial difference map or the initial difference correction formula stored in advance can be accurately corrected to correspond to the change over time by using the temporal difference value Vc1. Next, at steps S304 to 305, the energization of the heater unit 6 is stopped, and the sensor element is cooled. Then, at steps S306 to S308, the PM detection unit 3 is energized, the PM detection signal Va based on the inter-detection-electrode resistance Rs is detected, and then the energization is stopped. At steps S309 to S311, the temperature compensation unit 4 is energized, the temperature compensation signal Vb based on the inter-compensation-electrode resistance Rb is detected, and then the energization is stopped. Next, at step S312, the temperature compensation signal Vb is subtracted from the PM detection signal Va to calculate the differential output V1.

At step S313, the temporal difference correction value Vdc is subtracted from the differential output V1 to calculate a correction output V3 (i.e., V3=V1−Vdc). As described above, the temporal difference correction value Vdc can be based on the temporal difference map or the temporal difference correction formula obtained by correcting the initial difference map or the initial difference correction formula corresponding to the initial difference correction value Vdi using the temporal difference value Vd. The temperature of the sensor element 10 can be detected or estimated, for example, by using the exhaust gas temperature sensor 401 arranged on the upstream side of the sensor element 10. Then, the temporal difference correction value Vdc can be calculated by reading a map value corresponding to the detected or estimated temperature and setting the difference correction value Vc, or calculated by using the temporal difference correction formula.

At step S314, it is determined whether the correction output V3 obtained by the correction using the difference correction value Vd has reached the predetermined output V0 (V3≥V0?). When a negative determination is made at step S314, control returns to step S306, and step S306 and the subsequent steps are repeated. When an affirmative determination is made at step S314, the process is ended, and control proceeds to the process for fault diagnosis.

Thus, even after a change over time, by performing the correction using the difference correction value Vc considering the change, the amount of PM deposition can be more accurately calculated.

### Embodiment 4

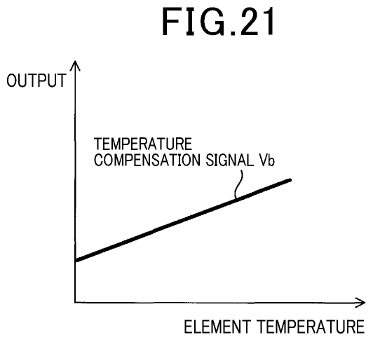

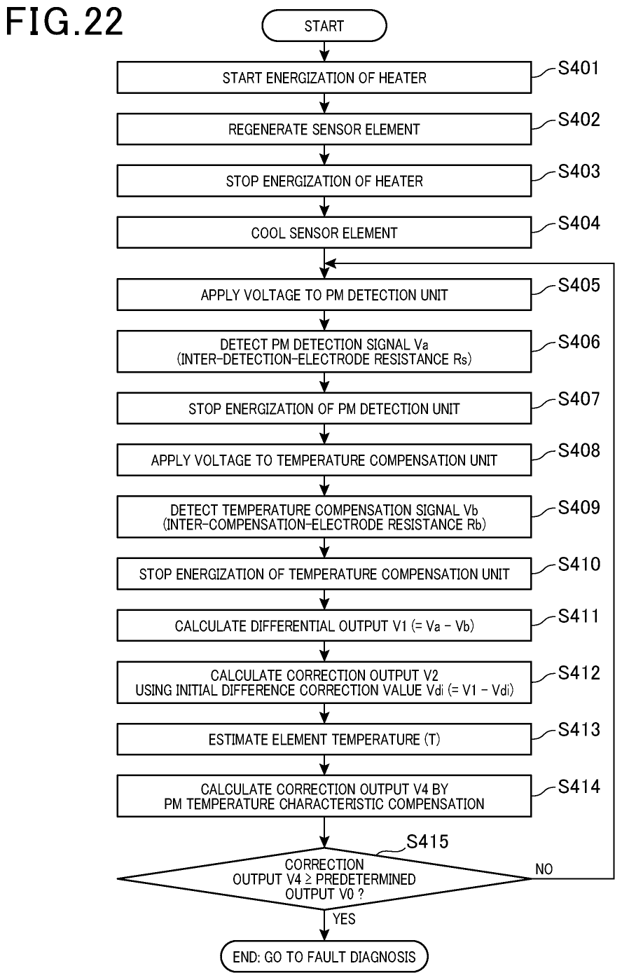

Embodiment 4 of the particulate matter detection device 1 will be described with reference to FIGS. 21 to 22. The particulate matter detection device 1 of the present embodiment has the same basic configuration as that of the particulate matter detection device 1 of the above embodiments, and differs from the particulate matter detection device 1 of the above embodiments in the method of correcting the differential output V1 after the calculation of the differential output V1 by the detection control unit 50 of the sensor control unit 5. In Embodiments 2 and 3, the differential output V1 is corrected on the basis of the difference between the output signals in the initial state or after the change over time. However, in the present embodiment, the differential output V1 is corrected considering the influence of temperature on the electrical resistance of the particulate matter.

The differences will be mainly described below.

As in the above embodiments, the use of the differential output V1 between the PM detection signal Va of the PM detection unit 3 and the temperature compensation signal Vb can eliminate the influence of temperature and noise on the electrical resistance of the detection conductive layer 2a. However, the PM detection signal Va based on the electrical resistance of the particulate matter itself is not temperature compensated. Thus, by correcting the differential output V1 corresponding to the amount of PM deposition on the basis of the temperature of the sensor element 10 (hereinafter referred to as element temperature), PM can be more accurately detected.

As shown in FIG. 21, the element temperature correlates, for example, with the output of the temperature compensation unit 4, and as the element temperature is increased, the output is increased. Thus, by obtaining the correlation in advance, the element temperature can be accurately estimated from the output of the temperature compensation unit 4. The PM current Ip that passes through the particulate matter also correlates with the element temperature, and is increased in proportion to the temperature. That is, the PM current Ip has the same tendency as that shown in FIG. 21. Thus, by obtaining in advance a temperature characteristic compensation formula also for the particulate matter itself from a relationship between the output and the temperature, temperature correction for the differential output V1 can be performed by using the estimated element temperature.

A particulate matter detection process performed by the sensor control unit 5 in this case will be described. A flow chart shown in FIG. 22 is obtained by changing part of the procedure of the flow chart shown in FIG. 18. Specifically, steps S401 to S412 are the same as steps S201 to S212 in FIG. 18, and are thus simply described, and step S413 and the subsequent steps which are the differences from the steps of the flow chart in FIG. 18 will be mainly described.

First, at steps S401 to 403, energization of the heater unit 6 is started, the regeneration process of the sensor element 10 is performed, and then the energization of the heater unit 6 is stopped. At subsequent step S404, the sensor element 10 is cooled. Subsequently, at steps S405 to S407, the PM detection unit 3 is energized, the PM detection signal Va based on the inter-detection-electrode resistance Rs is detected, and then the energization is stopped.

At steps S408 to S410, the temperature compensation unit 4 is energized, the temperature compensation signal Vb based on the inter-compensation-electrode resistance Rb is detected, and then the energization is stopped. Next, at step S411, the temperature compensation signal Vb is subtracted from the PM detection signal Va to calculate the differential output V1.

At step S412, the difference correction value Vdi is subtracted from the differential output V1 to calculate the correction output V2 (i.e., V2=V1−Vdi). As described above, the difference correction value Vdi can be stored in advance as the map value or the difference correction formula for a relationship between the difference between the outputs and the temperature in the initial state.

Next, at step S413, the element temperature is measured. At this time, by using the correlation shown in FIG. 21, the element temperature is estimated from the temperature compensation signal Vb of the temperature compensation unit 4. At subsequent step S414, on the basis of the estimated element temperature and the temperature characteristic compensation formula for the particulate matter, the temperature characteristic for the correction output V2 is corrected to calculate a correction output V4.

Then, at step S415, it is determined whether the correction output V4 obtained by the correction has reached the predetermined output V0 (V4≥V0?). When a negative determination is made at step S415, control returns to step S405, and step S405 and the subsequent steps are repeated. When an affirmative determination is made at step S415, the process is ended, and control proceeds to the process for fault diagnosis.

Thus, the correction output V2 is further corrected on the basis of the temperature characteristic of the particulate matter. Thus, for the PM detection signal Va of the PM detection unit 3, the temperature characteristic can be corrected not only for the output based on the detection conductive layer 2a but also for the output based on the deposited particulate matter, and thus the amount of PM deposition can be more accurately calculated.

### Embodiment 5

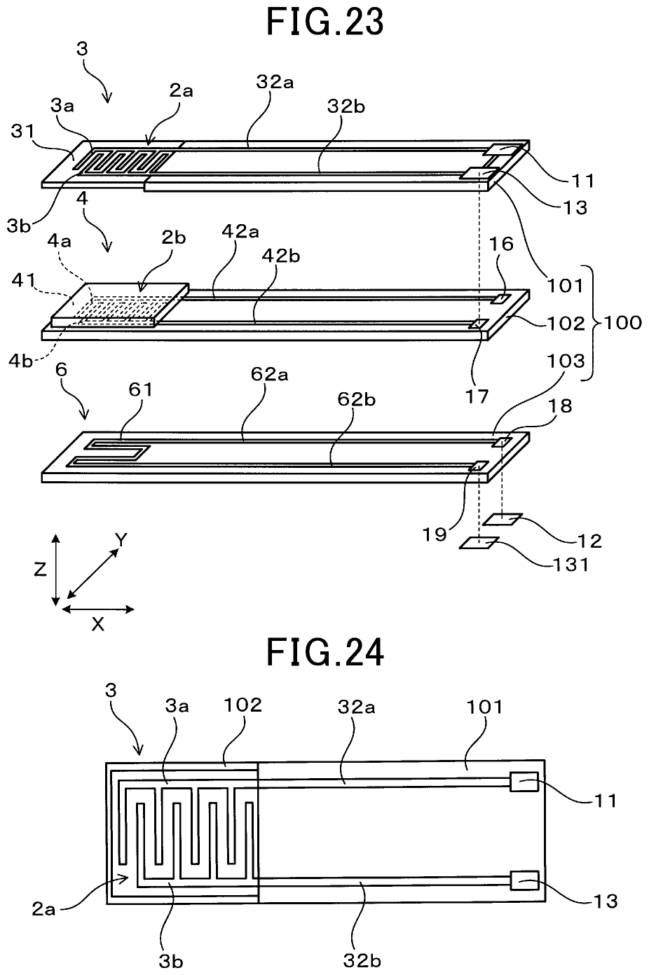

Embodiment 5 of the particulate matter detection device 1 will be described with reference to FIGS. 23 to 24. In FIG. 23, the particulate matter detection device 1 of the present embodiment has the same basic configuration as that of the particulate matter detection device 1 of Embodiment 1, and differs from the particulate matter detection device 1 of Embodiment 1 only in the electrode shape of the sensor element 10. The sensor control unit 5 has the same configuration as that of Embodiment 1, and is not shown in the drawings. The differences will be mainly described below.

In the present embodiment, the sensor element 10 includes the insulating plates 101 to 103 constituting the insulating substrate 100, and the PM detection unit 3, the temperature compensation unit 4, and the heater unit 6 that are supported by the insulating substrate 100. The PM detection unit 3, the temperature compensation unit 4, and the heater unit 6 are laminated in this order with the insulating plates 101 to 103 interposed therebetween.

The PM detection unit 3 includes the detection conductive layer 2a, and the pair of detection electrodes 3a and 3b arranged to face each other on the deposition surface 31 of the detection conductive layer 2a. The detection electrodes 3a and 3b are each formed to have a comb shape, and are arranged so that a plurality of linear electrodes extending in the width direction Y of the detection electrode 3a and a plurality of linear electrodes extending in the width direction Y of the detection electrode 3b alternately face each other with a predetermined space therebetween in the longitudinal direction X. The detection electrodes 3a and 3b are connected to the first output terminal 11 and the common ground terminal 13 formed on the upper surface of the insulating plate 101 via the pair of lead units 32a and 32b, respectively.

The temperature compensation unit 4 includes the temperature compensation conductive layer 2b, and the pair of temperature compensation electrodes 4a and 4b arranged to face each other on the non-deposition surface 41 of the temperature compensation conductive layer 2b. The temperature compensation electrodes 4a and 4b are arranged to face each other with a predetermined space therebetween in the width direction Y. The temperature compensation electrodes 4a and 4b are each formed to have a comb shape, and are arranged so that a plurality of linear electrodes extending in the width direction Y of the temperature compensation electrode 4a and a plurality of linear electrodes extending in the width direction Y of the temperature compensation electrode 4b alternately face each other with a predetermined space therebetween in the longitudinal direction X. The temperature compensation electrodes 4a and 4b are connected to the second output terminal 12 formed on the lower surface of the insulating plate 103 and the common ground terminal 13 formed on the upper surface of the insulating plate 101 via the pair of lead units 42a and 42b and the conductive portions 16 and 17, respectively.

The ends of the heater electrode 61 of the heater unit 6 are connected to the second output terminal 12 and the ground terminal 131 formed on the lower surface of the insulating plate 103 via the pair of lead units 62a and 62b and the conductive portions 18 and 19, respectively. Thus, the ground terminal 131 of the heater electrode 61 does not necessarily need to be shared with the PM detection unit 3 and the temperature compensation unit 4.

As described above, the PM detection unit 3 and the temperature compensation unit 4 may have a structure including the comb-shaped electrodes having the same shape. By connecting the PM detection unit 3 and the temperature compensation unit 4 to the common ground terminal 13, the output is temperature compensated and the influence of noise is eliminated, and thus the amount of PM deposition can be accurately detected. Also, in this case, the particulate matter detection device can have a structure including four terminals, and thus can achieve a simple configuration and a reduction in manufacturing cost.

The present disclosure is not limited to the above embodiments, but is applicable to various embodiments without departing from the scope of the present disclosure.

For example, the above embodiments show an example in which the particulate matter detection device is applied to the exhaust gas purification system of the automobile engine, but the particulate matter detection device is not limited to the application to the combustion exhaust gas from the engine or the like, and is applicable to any measured gas containing particulate matter.

What is claimed is:

1. A particulate matter detection device comprising:
a sensor element for detecting particulate matter contained in measured gas; and
a detection control unit connected to the sensor element, wherein:
the sensor element includes a particulate matter detection unit and a temperature compensation unit;
the particulate matter detection unit includes a detection conductive layer that is composed of a conductive material having a higher electrical resistivity than the particulate matter and has a deposition surface on which the particulate matter is deposited, and a pair of detection electrodes that are arranged on the deposition surface, and an electrical resistance between the pair of detection electrodes varies according to a deposition amount of particulate matter;
the temperature compensation unit includes a temperature compensation conductive layer that is composed of the conductive material and has a non-deposition surface arranged at a position at which the particulate matter is not deposited, and a pair of temperature compensation electrodes that are arranged on the non-deposition surface;
the pair of detection electrodes are connected to a first output terminal and a common ground terminal, respectively;
the pair of temperature compensation electrodes are connected to a second output terminal and the common ground terminal, respectively;
the detection control unit includes a detection circuit unit and a particulate matter amount calculation unit;
the detection circuit unit is connected to the first output terminal and detects a first output signal based on the electrical resistance between the pair of detection electrodes, and is connected to the second output terminal and detects a second output signal based on an electrical resistance between the pair of temperature compensation electrodes; and
the particulate matter amount calculation unit calculates the deposition amount of particulate matter on the basis of a differential output between the first output signal and the second output signal.

2. The particulate matter detection device according to claim 1, wherein the particulate matter amount calculation unit corrects the differential output by using an initial difference which is a differential output between the first output signal and the second output signal in an initial state in which the particulate matter is not deposited on the deposition surface.

3. The particulate matter detection device according to claim 2, wherein the particulate matter amount calculation unit sets an initial difference correction value with reference to an initial difference map or an initial difference correction formula that defines a relationship between the initial difference and a temperature, and obtains a correction output by subtracting the initial difference correction value from the differential output.

4. The particulate matter detection device according to claim 1, wherein:
the sensor element further includes a heater unit that includes a heater electrode that generates heat by energization, and the heater unit is provided for performing a regeneration process in which the particulate matter deposited on the deposition surface is combusted and removed by heat generation of the heater electrode; and
the particulate matter amount calculation unit corrects the differential output by using a temporal difference which is a differential output between the first output signal and the second output signal after the regeneration process is performed by the heater unit.

5. The particulate matter detection device according to claim 4, wherein the particulate matter amount calculation unit sets a temporal difference correction value with reference to a temporal difference map or a temporal difference correction formula that defines a relationship between the temporal difference and a temperature, and obtains a correction output by subtracting the temporal difference correction value from the differential output.

6. The particulate matter detection device according to claim 5, wherein after the regeneration process is performed by the heater unit, the particulate matter amount calculation unit detects a temporal difference value between the first output signal and the second output signal, and sets the temporal difference map or the temporal difference correction formula by using the temporal difference value.

7. The particulate matter detection device according to claim 4, wherein the heater electrode is connected to the common ground terminal.

8. The particulate matter detection device according to claim 4, wherein energization of the heater electrode, detection of the first output signal, and detection of the second output signal are performed at different timings.

9. The particulate matter detection device according to claim 1, wherein the particulate matter amount calculation unit estimates a temperature of the sensor element from an output of the pair of temperature compensation electrodes, and corrects the differential output on the basis of the estimated temperature and a temperature characteristic of the particulate matter.

10. The particulate matter detection device according to claim 1, wherein the particulate matter detection unit and the temperature compensation unit are located at positions facing each other with an insulating substrate interposed therebetween.

11. The particulate matter detection device according to claim 10, wherein:
a surface of the detection conductive layer on a side opposite to the insulating substrate is the deposition surface; and
a surface of the temperature compensation conductive layer on a side opposite to the insulating substrate is the non-deposition surface.

12. The particulate matter detection device according to claim 10, wherein in the temperature compensation unit, the temperature compensation conductive layer and the pair of temperature compensation electrodes are entirely covered with a gas-permeable insulating film.

13. The particulate matter detection device according to claim 12, wherein the gas-permeable insulating film is composed of a porous material having a plurality of communication holes that allow a gas component contained in measured gas to pass through or an oxide material that ionizes the gas component and allows the gas component to pass through.

14. The particulate matter detection device according to claim 1, wherein the particulate matter detection unit and the temperature compensation unit are arranged adjacent to each other on the same side of an insulating substrate.

15. The particulate matter detection device according to claim 14, wherein:
the detection conductive layer and the temperature compensation conductive layer constitute an integrated conductive layer;
a surface of the conductive layer on a side opposite to the insulating substrate is the deposition surface; and
a surface of the conductive layer on the insulating substrate side is the non-deposition surface.

16. The particulate matter detection device according to claim 1, wherein the conductive material has a surface electrical resistivity ρ in a range of 1.0×10⁷ to 1.0×10¹⁰ Ω·cm in a temperature range of 100 to 500° C.

17. The particulate matter detection device according to claim 16, wherein the conductive material is ceramic having a perovskite structure represented by a molecular formula of ABO₃, and an A site of the molecular formula is at least one selected from La, Sr, Ca, and Mg, and a B site of the molecular formula is at least one selected from Ti, Al, Zr, and Y.

18. The particulate matter detection device according to claim 17, wherein a main component of the A site is Sr and a secondary component of the A site is La, and the B site is Ti.
